(19) United States
(12) Patent Application Publication
(10) Pub. No.: US 2011/0227758 A1
(43) Pub. Date: Sep. 22, 2011

(54) Interactive Mobile Service System

(76) Inventors: Chao-Kai Liu, Taipei City (TW); Sheng-Lin Chou, Hsinchu County (TW); Yien-Chang Liao, Hsinchu County (TW)

(21) Appl. No.: 12/783,577

(22) Filed: May 20, 2010

(30) Foreign Application Priority Data
Mar. 22, 2010 (TW) 099108322

(51) Int. Cl. H04W 4/00; G06F 21/00; G06F 15/16; G08G 1/09

(52) U.S. Cl. 340/905; 726/11; 709/217; 370/338

(57) ABSTRACT

An interactive mobile service system for a transportation system includes a plurality of vehicle hosts deposited in a plurality of vehicles of the transportation system, and a plurality of servers for providing a plurality of services for the plurality of vehicle hosts, wherein the plurality of vehicle hosts request the plurality of servers to provide the plurality of services via a worldwide interoperability for microwave access network.

### BACKGROUND OF THE INVENTION

1. Field of the Invention

The present invention relates to an interactive mobile service system, and more particularly, to an interactive mobile service system for increasing pleasures of taking mass transportation vehicles of a transportation system, and effectively enhancing safety.

2. Description of the Prior Art

A taxi (or cab) constitutes a portion of the modern transportation system, and is capable of compensating a deficiency of mass transportation vehicles including buses, mass rapid transportation (MRT), trains, etc. Generally, in order to increase incentives for passengers to take taxis, taxi drivers often provide newspapers and magazines or play TV programs, videos, broadcasts, music, etc., via vehicle multimedia systems. However, other than these activities, passengers can do limited activities while taking taxis.

Furthermore, because social criminal cases related to taxis keep happened, people often have extra considerations while taking taxis, which is unfavorable for taxi business.

### SUMMARY OF THE INVENTION

It is therefore an objective of the present invention to provide an interactive mobile service system.

The present invention discloses an interactive mobile service system for a transportation system. The interactive mobile service system includes a plurality of vehicle hosts, deposited in a plurality of vehicles of the transportation system, and a plurality of servers, for providing a plurality of services for the plurality of vehicle hosts, wherein the plurality of vehicle hosts request the plurality of servers providing the plurality of service via a worldwide interoperability for microwave access network.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an interactive mobile service system according to an embodiment of the present invention.

FIG. 2 is a functional block diagram of the vehicle host according to an embodiment of the present invention.

FIG. 3A and FIG. 3B are schematic diagrams of depositing the vehicle host of FIG. 2.

### DETAILED DESCRIPTION

In order to enhance the pleasure and safety of taking taxis, the present invention provides an interactive mobile service system for a transportation system via a worldwide interoperability for microwave access (WiMAX) system which has merits of broadband and high speed.

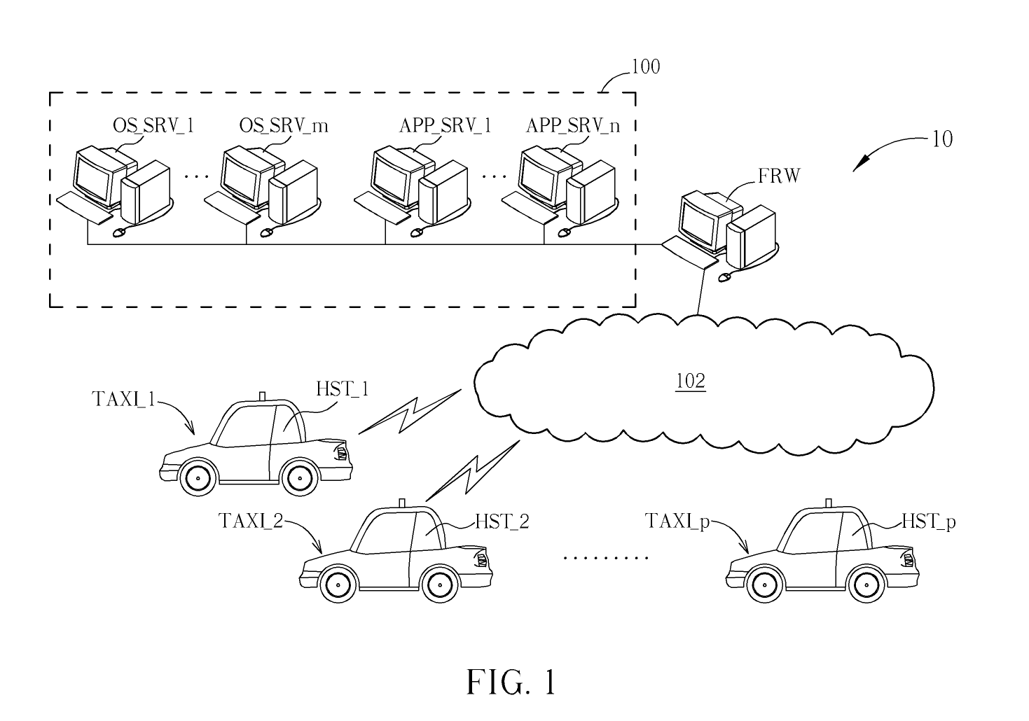

Please refer to FIG. 1, which is a schematic diagram of an interactive mobile service system 10 according to an embodiment of the present invention. The interactive mobile service system 10 is utilized in a transportation system, and includes a main controller 100 and vehicle hosts HST_1˜HST_p. The vehicle hosts HST_1˜HST_p are deposited in taxis TAXI_1˜TAXI_p of the transportation system, and are utilized for outputting request signals to the main controller 100, and receiving corresponding service contents via a WiMAX network 102. The main controller 100 includes a firewall FRW, servers OS_SRV_1˜OS_SRV_m and APP_SRV_1˜APP_SRV_n, where the servers OS_SRV_1˜OS_SRV_m are in charge of system-related services, such as system operations, user account managements, certifications, vehicle host updating, while the servers APP_SRV_1˜APP_SRV_n are in charge of application-related services, which are detailed as follows.

The interactive mobile service system 10 is established upon the WiMAX network 102 and is a master-slave structure combined with transportation vehicles. Passengers can establish connections with the main controller 100 via the vehicle hosts HST_1˜HST_p, so as to acquire traffic information and consumer information, play games, surf internet, watch TV programs, send secure text messages, vote, attend web forum, acquire electronic coupons, watch advertisement, etc. Noticeably, the services provided by the main controller 100 are not limited to specific types, and those skilled in the art should readily make proper alterations or modifications according to system requirements. In short, when taking a taxi TAXI_x within the taxis TAXI_1˜TAXI_p, a passenger can utilize the vehicle host HST_x deposited on the taxi TAXI_x to acquire the services provided by the servers APP_SRV_1˜APP_SRV_n via the WiMAX network 102. Furthermore, if the passenger has registered in the interactive mobile service system 10, the servers OS_SRV_1˜OS_SRV_m can recognize the passenger, so as to provide personalized services.

For clear illustration, different operations are described as follows.

1. Traffic information broadcast function. Taxi fees are often charged based on mileage or driving time. A passenger unfamiliar with traffic information or destination has to worry about whether a driver takes a detour. On the other hand, a driver familiar with traffic information can properly avoid congested roads, while has to worry the passenger mistaken it as a detour. Therefore, except for performing navigation via a global positioning satellite (GPS) system, the present invention can further provide functions such as traffic information broadcast or path planning via one of the servers APP_SRV_1˜APP_SRV_n. As a result, the passenger can acknowledge whether the driver takes the detour deliberately or strays from the destination, which can avoid unnecessary disputes between the passenger and the driver, and further ensure safety, so as to enhance the incentive of taking a taxi.

2. Consumer or life information function. The present invention can further provide consumer or life information near passing locations or a destination via one of the servers APP_SRV_1˜APP_SRV_n. That is, when a passenger takes one of the taxis TAXI_1˜TAXI_p, the present invention can further respond information of a current location via a corresponding vehicle host, and transmit consumer or life information via a corresponding server. As a result, the passenger can inquire consumer or life information such as restaurants, street venders, amusement parks, movie theaters, shopping malls, government offices, hospitals and pharmacies near passing locations or the destination, so as to increase the pleasure of taking a taxi.

3. Electronic coupon or advertisement function. As mentioned above, the present invention can provide consumer or life information near passing locations or the destination via specific servers. Furthermore, the present invention can provide download services of electronic coupons via one of the servers APP_SRV_1˜APP_SRV_n, or advertise via another server. For example, the present invention can provide discount information of nearby stores according to passing locations or the destination, such that the passenger can request corresponding servers to send the electronic coupons to mobile phones or an electronic mail box of the passenger via the vehicle host, or acquire the electronic coupons via a photographing function of a mobile phone. Noticeably, the electronic coupon or advertisement function generally cooperates with stores, and can further charge a specific fee to increase revenue. On the other hand, since this business model is related to locations passed by the taxi, which is more attractive to the passenger, so as to increase advertising benefit.

4. Playing games, surfing websites, demonstrating network TV programs, attending web forums, and voting function. In order to increase the pleasure of taking a taxi, the present invention can provide services, such as playing games, surfing webpages, demonstrating network TV programs, attending web forums, and voting, via specific servers of the servers APP_SRV_1˜APP_SRV_n. For example, the passenger can select an intended game via the vehicle host, such that a corresponding server will start the game. Similarly, when the passenger intends to surf websites, watch network TV programs, attend a web forum, or vote, corresponding servers output related contents to the vehicle host, so as to increase the pleasure of taking a taxi.

5. Safety protection function. In order to ensure safety of the passenger, the present invention can further send information such as safety text messages, voices to a specific person via one of the servers APP_SRV_1˜APP_SRV_n. For example, after taking a taxi, the passenger can utilize the vehicle host to send a text message to mobile phones of family or friends to follow tracks via related servers, so as to avoid social criminal cases.

6. Account management function. In order to provide personalized services, the present invention can further providing account registration and management function. In other words, the passenger can register an account via network, voice call, etc. in advance, or register via the vehicle host while taking one of the taxis TAXI_1˜TAXI_p. When the passenger takes one of the taxis TAXI_1˜TAXI_p, a related server of the servers OS_SRV_1˜OS_SRV_m can recognize an identity of the passenger, so as to provide personalized services. For example, if the passenger is interested in computer, communication, consumer-electronics (3C) products, the related server of the servers APP_SRV_1˜APP_SRV_n can provide electronic coupons of 3C products or play advertisements of 3C products. In addition, account information, password management, etc. of passengers can be stored in a database, which is well known by those skilled in the art.

7. Automatic updating function. With respect to operating software or data of the vehicle hosts HST_1˜HST_p, the present invention can perform automatic updating via one of the servers OS_SRV_1˜OS_SRV_m, so as to improve flaws or enhance functionality.

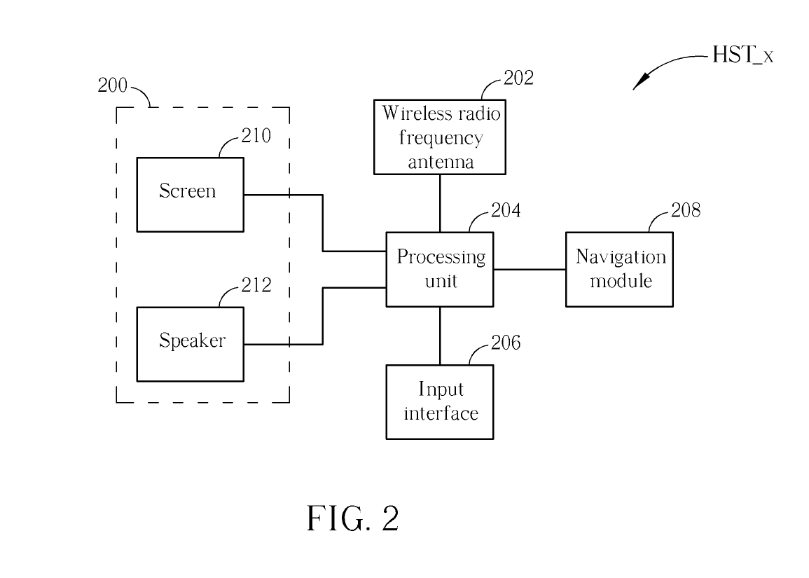

The above different functions are utilized for illustrating the concept of the present invention, and those modifications or alterations according to the spirit of the present invention belong to the scope of the present invention. Besides, the servers OS_SRV_1˜OS_SRV_m and APP_SRV_1˜APP_SRV_n or the vehicle hosts HST_1˜HST_p should be modified according to required functions, which is well known by those skilled in the art. For example, FIG. 2 is a functional block diagram of the vehicle host HST_x according to an embodiment of the present invention. The vehicle host HST_x includes an output interface 200, a wireless radio frequency antenna 202, a processing unit 204, an input interface 206 and a navigation module 208. The output interface 200 includes a screen 210 and a speaker 212, which output corresponding pictures and sounds according to processing results of the processing unit 204, respectively. The input interface 206 receives passenger instructions, and can be realized by a touch screen, or keys, etc. After the input interface 206 receives the control instructions, the processing unit 204 sends control instructions to the main controller 100 via the wireless radio frequency antenna 202, and receives responded service contents, so as to output the service contents via the output interface 200. The navigation module 208 preferably includes a GPS system receiver, for acquiring position information, so as to perform navigation or positioning. The processing unit 204 can provide proper traffic information and consumer information according to the position information acquired by the navigation module 208.

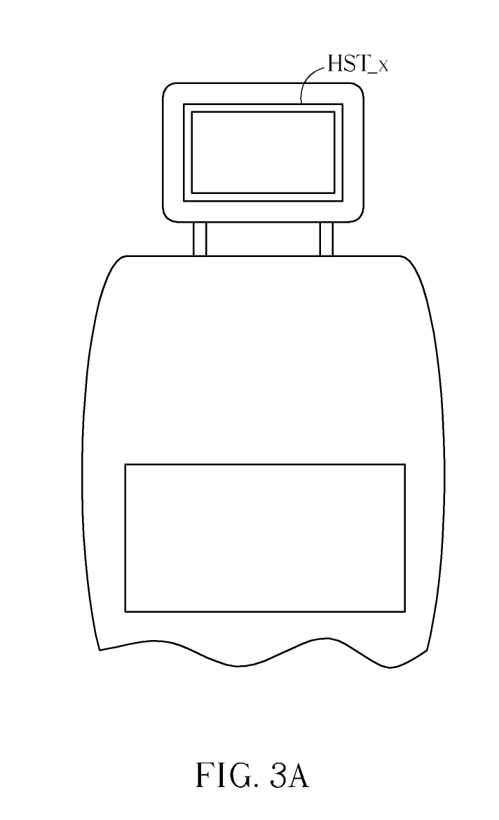

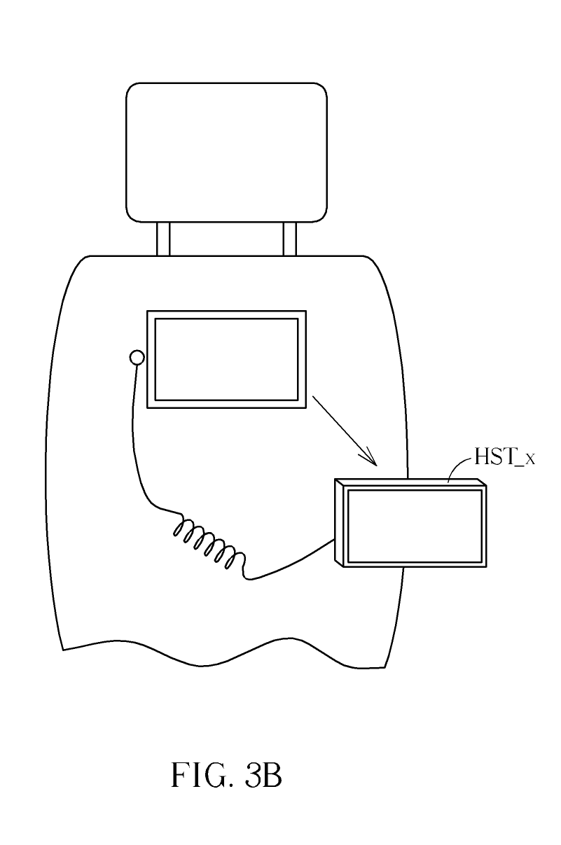

Noticeably, the vehicle host HST_x shown in FIG. 2 is only utilized for illustrating the spirit of the present invention, and does not limit the scope of the present invention. Those skilled in the art should readily make alterations or modifications according to system requirements. For example, the vehicle host HST_x is deposited in the taxi, and the deposited location or method is not limited to any rule. For example, in FIG. 3A, the vehicle host HST_x is deposited on a back of a headrest, while in FIG. 3B, the vehicle host HST_x is deposited on a back of a seat, and can be taken down to operate. Besides, the taxis TAXI_1˜TAXI_p are only exemplary embodiments, and in practice, any vehicle related to mass transportation can apply the service structure of the present invention.

As mentioned above, conventionally, passengers can do limited activities, such as listening to radio, reading newspaper, etc., when taking taxis. Besides, people have extra considerations due to social criminal cases related to taxis, which is unfavorable for taxi business. In comparison, the present invention can provide plenty of information and interactive functions via WiMAX network, so as to increase the pleasure of taking taxis. Moreover, the present invention can provide safety protection mechanism to avoid social criminal cases.

To sum up, the present invention can enhance the pleasure of taking mass transportation vehicles, and effectively increase safety.

Those skilled in the art will readily observe that numerous modifications and alterations of the device and method may be made while retaining the teachings of the invention.

What is claimed is:

1. An interactive mobile service system for a transportation system, comprising:
a plurality of vehicle hosts, deposited in a plurality of vehicles of the transportation system; and
a plurality of servers, for providing a plurality of services for the plurality of vehicle hosts;
wherein the plurality of vehicle hosts request the plurality of servers to provide the plurality of services via a worldwide interoperability for microwave access (WiMAX) network.

2. The interactive mobile service system of claim 1, wherein the plurality of vehicles are a plurality of taxis.

3. The interactive mobile service system of claim 1, wherein each vehicle host of the plurality of vehicle hosts comprises:
an output interface;
a wireless radio frequency antenna, for transmitting and receiving wireless electric waves via the WiMAX network; and
a processing unit, coupled to the output interface and the wireless radio frequency antenna, for outputting a service request signal to a server of the plurality of servers via the wireless radio frequency antenna, and receiving a service content responded by the server, to output the service content via the output interface.

4. The interactive mobile service system of claim 3, wherein the output interface comprises:
a screen, for outputting pictures corresponding to the service content; and
a speaker, for outputting sounds corresponding to the service content.

5. The interactive mobile service system of claim 3, wherein each of the vehicle hosts further comprises an input interface, for receiving a user control signal, to generate the service request signal.

6. The interactive mobile service system of claim 5, wherein the input interface is a touch screen.

7. The interactive mobile service system of claim 5, wherein the input interface is a plurality of keys.

8. The interactive mobile service system of claim 3, wherein each of the vehicle hosts further comprises a navigation module.

9. The interactive mobile service system of claim 8, wherein a server of the plurality of servers provides traffic information for the navigation module when the navigation module operates.

10. The interactive mobile service system of claim 1, wherein the plurality of servers further connect to the WiMAX network via a firewall.

11. The interactive mobile service system of claim 1, wherein a server of the plurality of servers is utilized for providing consumer information.

12. The interactive mobile service system of claim 1, wherein a server of the plurality of servers is utilized for linking websites.

13. The interactive mobile service system of claim 1, wherein a server of the plurality of servers is utilized for providing games.

14. The interactive mobile service system of claim 1, wherein a server of the plurality of servers is utilized for demonstrating network TV programs.

15. The interactive mobile service system of claim 1, wherein a server of the plurality of servers is utilized for sending text messages.

16. The interactive mobile service system of claim 1, wherein a server of the plurality of servers is utilized for acquiring a polling result.

17. The interactive mobile service system of claim 1, wherein a server of the plurality of servers is utilized for providing a web forum.

18. The interactive mobile service system of claim 1, wherein a server of the plurality of servers is utilized for providing a plurality of electronic coupons.

19. The interactive mobile service system of claim 1, wherein a server of the plurality of servers is utilized for advertising.

20. The interactive mobile service system of claim 1, wherein a server of the plurality of servers is utilized for updating operations of the plurality of vehicle hosts.

21. The interactive mobile service system of claim 1 further comprising a database, for storing user information.
